(19) United States
(12) Patent Application Publication
(10) Pub. No.: US 2023/0145997 A1
(43) Pub. Date: May 11, 2023

(54) POOL AND SPA OPERATIONAL PARAMETER SHARING VIA NETWORK CONNECTIONS

(71) Applicant: ZODIAC POOL SYSTEMS LLC, Carlsbad, CA (US)

(72) Inventor: Hwa Leung Heng, Carlsbad, CA (US)

(21) Appl. No.: 17/985,259

(22) Filed: Nov. 11, 2022

Related U.S. Application Data
(60) Provisional application No. 63/278,271, filed on Nov. 11, 2021.

(51) Int. Cl. G05B 19/042

(52) U.S. Cl. CPC G05B 19/0426

(57) ABSTRACT

Techniques described herein relate to devices, apparatuses, systems, and methods for sharing operational parameters for operational control of a pool or spa. In an example, a process may include accessing a set of operational parameters, detecting proximity of a user device with respect to a pool system, and responsive to detecting the proximity of the user device, sending the set of operational parameters to the user device.

### BACKGROUND

Pool and spa systems may include equipment for heating, monitoring, and/or controlling conditions of the pool or spa. The equipment may be configured to generate operational parameter information. This may be stored locally and/or shared. This operational parameter information may be useful for servicing and/or controlling the equipment.

### BRIEF SUMMARY

Various examples are described including systems, methods, and devices relating to operational parameter sharing in pool and spa systems.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a computer-implemented method for sharing operational parameters for operational control of a pool or spa. The computer-implemented method includes accessing a set of operational parameters. The computer-implemented method also includes detecting proximity of a user device with respect to a pool system. The computer-implemented method also includes responsive to detecting the proximity of the user device, sending the set of operational parameters to the user device. Other embodiments of this aspect include corresponding computer systems, apparatus, and computer programs recorded on one or more computer storage devices, each configured to perform the actions of the methods.

Another general aspect includes a pool system for sharing operational parameters for operational control of a pool or spa. The pool system also includes a controller configured to: access a set of operational parameters, detect proximity of a user device with respect to a pool system; and responsive to detecting the proximity of the user device, and send the operational parameters to the user device. Other embodiments of this aspect include corresponding computer systems, apparatus, and computer programs recorded on one or more computer storage devices, each configured to perform the described functions.

Another general aspect includes a computer-implemented method for sharing operational parameters for operational control of a pool or spa. The computer-implemented method includes receiving, at a cloud-connected server system, a set of operational parameters relating to operation of the pool or spa. The computer-implemented method also includes receiving, from a user device, a request to access the set of operational parameters. The computer-implemented method also includes responsive to receiving the request, authenticating the user device. The computer-implemented method also includes after authenticating the user device, sending at least a portion of the set of operational parameters to the user device. Other embodiments of this aspect include corresponding computer systems, apparatus, and computer programs recorded on one or more computer storage devices, each configured to perform the actions of the methods.

Another general aspect includes a method for sharing operational parameters for operational control of a pool or spa. The method includes receiving, by a controller of a pool system and using a first communication protocol, a set of operational parameters from a connected device of the pool system. The method also includes sending, by the controller and using a second communication protocol, the operational parameters to a pool automation system of the pool system. The method also includes sending, by the pool automation system and using a third communication protocol, the operational parameters to an external computing device. Other embodiments of this aspect include corresponding computer systems, apparatus, and computer programs recorded on one or more computer storage devices, each configured to perform the actions of the methods.

Another general aspect includes a method for sharing operational parameters for operational control of a pool or spa. The method includes receiving, by a controller of pool equipment and using a first communication protocol, operational parameters from an automation system of a pool system. The method also includes storing the operational parameters in memory of the pool equipment that is associated with the automation system. The method also includes detecting a connection between the pool equipment and an external computing device. The method also includes sending, using a second communication protocol, the operational parameters to the external computing device based on detecting the connection. Other embodiments of this aspect include corresponding computer systems, apparatus, and computer programs recorded on one or more computer storage devices, each configured to perform the actions of the methods.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIG. 1 illustrates a pool system for operational parameter sharing, according to at least one example.

FIG. 2 illustrates a pool system for operational parameter sharing, according to at least one example.

FIG. 3 illustrates a flow chart depicting an example process for controlling and/or monitoring pool equipment based on operational parameter sharing, according to at least one example.

FIG. 4 illustrates a flow chart depicting an example process for controlling and/or monitoring pool equipment based on operational parameter sharing, according to at least one example.

FIG. 5 illustrates a flow chart depicting an example process for controlling and/or monitoring pool equipment based on operational parameter sharing, according to at least one example.

FIG. 6 illustrates a flow chart depicting an example process for controlling and/or monitoring pool equipment based on operational parameter sharing, according to at least one example.

FIG. 7 illustrates examples of components of a computer system, according to at least one example.

### DETAILED DESCRIPTION

Examples are described herein in the context of operational parameter sharing in pool and spa systems. Those of ordinary skill in the art will realize that the following description is illustrative only and is not intended to be in any way limiting. For example, the techniques described herein can be used to share operational parameters in systems that include various connected equipment and devices that communicate via different protocols, not just those in pool and spa systems. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer’s specific goals, such as compliance with application and business-related constraints, and that these specific goals will vary from one implementation to another and from one developer to another.

Pool systems may include equipment such as heaters, controllers, filters, motors, pumps, lighting systems, lights, and the like configured to perform certain functions with respect to a body of water. For example, a heater may be configured to heat the body of water, while the controller may be configured to set a temperature, configure lights, and the like. Some pool systems may also include a pool automation system that enables additional and more refined user control and operation of the pool system. Some equipment and pool automation systems may include network interfaces to enable communication with network-connected devices such as electronic user devices (e.g., smartphones, tablets, laptops, watches, etc.).

The techniques described herein are directed to techniques for sharing operational parameters of pool and spa systems. The operational parameters may relate to equipment and/or other connected devices of the systems. The operational parameters may include historical data such as file logs relating to the operation of a heater, control data such as a schedule for operating a set of lights, and any other suitable operational data relating to operating a pool or spa system. An example pool system may include connected equipment, a pool automation system, and one or more connected devices. Some of these components of the pool system may include memory to store certain data relating to their respective operation. This data may be helpful for technicians tasked with working on the pool system. This data may also be helpful for pool and spa owners and/or operators. The techniques described herein provide various approaches for sharing this data by and among components of the pool system and with a cloud-connected server system. As each component of the system may support various communication protocols, the operational parameters may be shared over the various communication protocols, depending on the embodiment.

Conventional approaches for managing operational parameters in pool systems may have required owner-users to grant limited access to technicians to obtain operational parameters, did not allow sharing of operational parameters between components (e.g., required accessing parameters from each component), and had other technical problems as described herein. The techniques described herein provide various technical improvements to the field of pool automation/control systems and provide various technical solutions to the technical problems identified herein. For example, the techniques described herein provide improved methods for sharing operational parameters in a way that is more secure and robust than previous methods. Rather than requiring owner-users to share credentials with technician-users (which can create security and privacy issues), the technician-users may utilize user devices with auto-authentication that enable authentication and sharing based on proximity. The technician-users are allowed to obtain certain parameters that are required for their specific purposes but are not otherwise granted access to all aspects of management. The controllers of the components of the system may include instructions that make decisions about access control. As an additional example, because the controllers are selective about what parameters are shared, bandwidth resources are conserved, along with memory needed to store operational parameters.

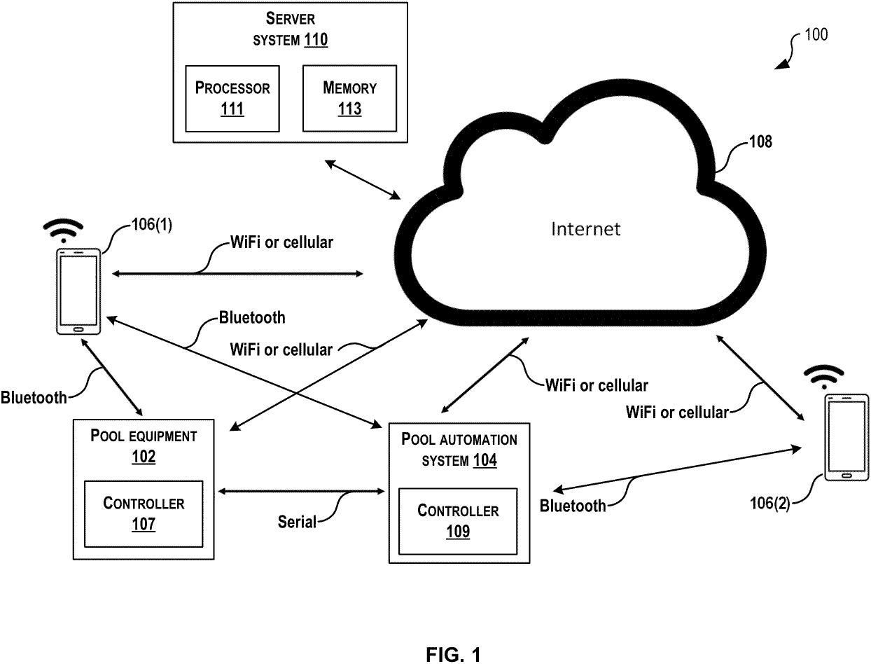

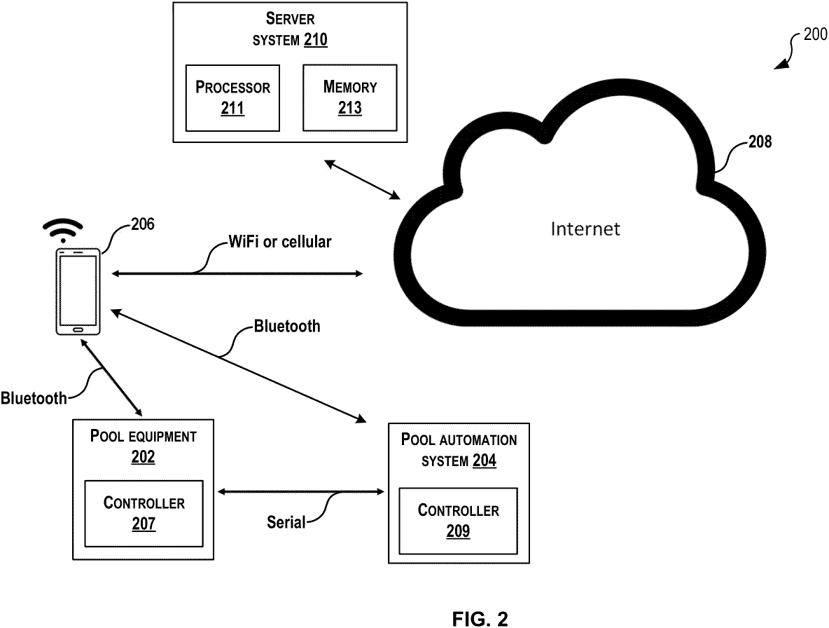

Turning now to the figures, FIG. 1 illustrates a pool system 100 for operational parameter sharing, according to at least one example. The pool system 100, which includes components of a pool system, may include pool equipment 102 and a pool automation system 104. In the pool system 100, the pool automation system 104 may be capable of connecting with the Internet 108, as compared to the pool system 200 of FIG. 2, in which a pool automation system 204 does not have such capability. The pool systems 100 and 200 are depicted as including multi-directional arrowed lines between certain elements. These arrowed lines may represent data connections of various types, as described herein. These arrowed lines are also labeled with example types of data connections that may be appropriate (e.g., Wi-Fi, cellular, Bluetooth or other near field connection, serial, power line communication (PLC), and the like). The example types should not be interpreted as limiting, as different types may be appropriate for different circumstances described herein.

The pool system 100 also includes user device 106(1) and user device 106(2) (referred to herein occasionally as user device(s) 106). Depending on the embodiment, either of the user devices 106 may be used by a technician to view and interact with the other elements of the pool system 100. In the technician embodiments, the user devices 106 may include specialized application(s) and/or specialized features to enable the technicians to view and interact with the other elements of the pool system 100. In some examples, at least one of the user devices 106 may be configured for customer use. For example, the user device 106(2) may include an application that enables a customer to connect to the pool automation system 104 and view and interact with the pool automation system 104 (e.g., adjust a temperature of a connected heater, change lighting configurations, etc.). The specific permissions and functions of the applications on the user devices 106 may depend on whether the permissions and/or functions are customer-focused or technician-focused. The specific permissions and functions may also depend on whether the user of the user device 106 has access to a local area network to which the system elements are connected and/or to a cloud-connected server system with which the system elements may share information.

The pool equipment 102 may include any suitable device or equipment used in the operation of the pool system, e.g., heater, lighting systems, lights, controller 107, filter system, motor, pump, or the like. The controller 107 of at least some of the pool equipment 102 may include electronic circuitry including, for example, onboard processing units and memory for storing computer-executable instructions. In some examples, the electronic circuitry may include specialized chips or controllers used to perform dedicated functions such as those described herein with respect to the flow charts.

In some examples, the pool equipment 102 may include any suitable number and type of sensors for sensing conditions of the pool equipment. Information from these sensors may be stored in the memory of the pool equipment 102, stored in connected memory, and the like before being shared with other devices, as described herein. In some examples, the information may represent operational parameters of the pool equipment 102. In some examples, the electronic circuitry of the pool equipment 102 may process the sensor information in order to form the operational parameters.

In some examples, the memory of the pool equipment 102 may store firmware and/or software that may be updated over time. At least some of the pool equipment 102 may also include interfaces for receiving and outputting information. For example, the pool equipment 102 may include communication interfaces for hardwired and/or networked communications, user interfaces for receiving and outputting information to users, and the like. In some examples, the pool equipment 102 may include a network interface (e.g., Bluetooth, Near-Field Communication (NFC), or other short-range communication interface) for establishing a data connection with a user device 106(1) and a serial interface (e.g., RS-485) for establishing a data connection with the pool automation system 104. In some examples, the pool equipment 102 may also include input components for users to input information at the user interfaces.

The pool automation system 104 may also include suitable componentry to enable communication with other devices and/or systems. For example, as introduced herein, the pool automation system 104 may include a serial interface (e.g., RS-485) for establishing a data connection with the pool equipment 102 and a network interface (e.g., WiFi interface, air interface, Bluetooth cellular interface, radio, or the like) for establishing a data connection with the Internet 108 (or other network) and/or the user device 106(2). For example, the Internet 108 in this example may represent a connection to a server system 110 that enables remote sharing of information between the pool automation system 104 and a network-connected user device 106(2). The server system 110 may be configured for processing communication from the devices 106. The pool automation system 104 may be configured to communicate with the user device 106(2) via a Bluetooth data connection. This may allow the pool automation system 104 to share operational parameters with the user device 106(2). In some examples, the data connection between the user device 106(2) and the pool automation system 104 may enable remote control, remote diagnostics, etc. of the pool automation system 104 by the user device 106(2).

The pool automation system 104 may include any suitable device or equipment used in the automation of the pool system. At least some of the pool automation system 104 may include a controller 109 including electronic circuitry including, for example, onboard processing units and memory for storing computer-executable instructions. In some examples, the electronic circuitry may include specialized chips or controllers used to perform dedicated functions such as those described with respect to the flow charts.

In some examples, the pool automation system 104 may include any suitable number and type of sensors for sensing conditions of the pool equipment and other accessories of the pool system. Information from these sensors may be stored in the memory of the pool automation system 104, stored in connected memory, and the like before being shared with other devices, as described herein. In some examples, the information may represent operational parameters of the pool equipment 102 and/or the pool automation system 104. In some examples, the electronic circuitry of the pool automation system 104 may process the sensor information in order to form the operational parameters.

In some examples, the memory of the pool automation system 104 may store firmware and/or software that may be updated over time. At least some of the pool automation system 104 may also include interfaces for receiving and outputting information. For example, the pool automation system 104 may include communication interfaces for hardwired and/or networked communications, user interfaces for receiving and outputting information to users, and the like.

In some examples, the pool automation system 104 and/or the pool equipment 102 may be connected to the Internet 108 and/or a local network such as a wide-area network provided at the location at which the pool automation system 104 and the pool equipment 102 are installed (e.g., at a pool site). In this example, the information shared with the server system 110 via the Internet 108 may also pass via the local network. A user such as a homeowner may use their user device 106 to connect to the server system 110 via the Internet 108 and/or the local network. This may be possible because the homeowner has the appropriate credentials (e.g., network name and password) for accessing the local network. In some examples, this may enable the homeowner to review operational parameters of the pool equipment 102 and/or the pool automation system 104 (e.g., via the local network or via the server system 110 and the Internet 108) and/or to control the operation of these devices.

The server system 110, which may be a cloud-connected server system, may include any suitable combination of elements to enable the techniques described herein. For example, the server system 110 may include a processor 111 and a memory 113. The memory 113 may be used to store operational parameters, such as those received from the other elements of the system. The memory 113 may also be configured to store computer-executable instructions that, when executed by the processor 111, cause the server system 110 to perform the techniques described herein.

In some examples, a technician who is at the pool site may not be able to review the same operational information and/or control the operation of these device via the server system 110 (and the Internet 108 and the local network). This may be because the technician does not have the appropriate credentials (e.g., network name and password) for accessing the local network and/or appropriate credentials for accessing the information stored by the server system 110. Data privacy and/or security considerations may govern this decision to not give access to the technician. In this example, using the techniques described herein, the technician may nevertheless access similar information from the pool equipment 102 and/or the pool automation system 104 by using their user device (e.g., the device 106(1)) to connect directly to the pool equipment 102 and/or the pool automation system 104 via a Bluetooth or other short distance data connection. In some examples, such as when the pool equipment 102 and/or the pool automation system 104 are not connected to the local network and/or to the Internet 108, the Bluetooth or other short distance data connection may be the primary approach for obtaining operational parameters from these devices. Once the user device 106, such as when operated by a technician, obtains the operational parameters, the user device 106 may upload the operational parameters (or other information) to the server system 110 via the Internet 108 (and a different network connection such as a cellular network connection or a WiFi connection with a network other than the local network). In some examples, the user device 106, when operated by the technician, may be authorized to write to the server system 110 (e.g., send data to the server system 110), but may be unauthorized to read information from the server system 110.

The user device 106(1) (and the user device 106(2)) may include any suitable componentry to enable communication in the manner described herein. For example, the user device 106 may include a network interface for communicating with the Internet 108 and a network interface for communicating with the pool equipment 102. The user device 106 may also include applications to enable specialized functions such as for interacting with the pool automation system 104, the pool equipment 102, and the like. The user device 106 also includes a display or other output component to enable viewing of information such as operational parameters received via the network interfaces. The user device 106 may also include input components to enable inputting of information to adjust operational properties of the connected pool equipment 102 and/or pool automation system 104.

The pool system 100 may be used to share operational parameters (or other information) with the user devices 106 in various ways. For example, in a remote monitoring situation, the pool equipment 102 may share information with the pool automation system 104, which may then push the information to the server system 110 via the Internet 108. This information may be pushed at any suitable cadence (e.g., every few minutes, every hour, at the end of every day, and the like) and/or based on any suitable triggering information (e.g., when new information is received, when requested, and the like). From here, the user device 106(2) may request the information from the server system 110 via the Internet 108. The user device 106(2) may also send control instructions via the Internet 108 to the pool automation system 104. In some examples, the pool automation system 104 may also share the information with the user device 106(2) via local connection such as Bluetooth, Wifi, NFC, or the like.

In some examples, certain triggering activities may be defined, either in the pool equipment 102, the pool automation system 104, and/or within an application of the user device 106(1), to determine when to begin sharing information with the user device 106(1) when the user device 106(1) is near the pool equipment 102 and/or the pool automation system 104. For example, as the user device 106(1) approaches the pool equipment 102 and the pool automation system 104, the pool equipment 102 and/or the pool automation system 104 may establish a Bluetooth connection with the user device 106(1) and begin sharing information. In some examples, this same connection may be used to view real-time readouts of the operational parameters of the pool equipment 102 and/or the pool automation system 104. For example, a technician may use their user device 106(1) to understand how the pool equipment 102 is functioning. In some examples, pushing of the operational parameters directly to the user device 106(1) may result in more efficient troubleshooting, maintenance, and other service activities. The user device 106(1) may also obtain historical data representing the operational parameters by accessing the server system 110 via the Internet 108 and/or connecting to the pool automation system 104. In some examples, the data flow may be two-way. For example, the user device 106(1) may be used to send information to the pool equipment 102 and/or to the pool automation system 104 via the Bluetooth connection or other short-range communication interface, the Internet 108, etc.

FIG. 2 illustrates a pool system 200 for operational parameter sharing, according to at least one example. The pool system 200, which includes components of a pool system, may include pool equipment 202 and a pool automation system 204. Similarly, the pool equipment 202, the pool automation system 203, user device 206, Internet 208, and server system 210 of pool system 200 are examples of the corresponding components in the pool system 100. As compared to the pool system 100, the pool automation system 204 may be incapable of forming a data connection with the Internet 208 and/or other user devices 206. Thus, as described in further detail below, the pool automation system 204 may maintain and/or establish a data connection with the pool equipment 202 (e.g., via a serial interface or other communication interface such as Bluetooth, WiFi, etc.) and share operational parameter information with the pool equipment 202. The pool equipment 202 may then store and/or share the operational parameter information with the user device 206. The user device 206 may then upload the operational parameter information from the pool automation system 204 to the server system 210 via the Internet 208. In some examples, the pool system 200 may be appropriate for systems in which the pool automation system 204 does not include a network connection with the Internet 208 or other over-the-air network.

As described above with respect to the pool equipment 102 and the pool automation system 104, the pool equipment 202 and the pool automation system 204 may generate operational parameter information in any suitable manner, which may be based on one or more sensors. This operational parameter information may include real-time data, historical data, or the like. In some examples, the data flow may be two-way. For example, the user device 206 may be used to send information to the pool equipment 202 and/or to the pool automation system 204 via the pool equipment 202.

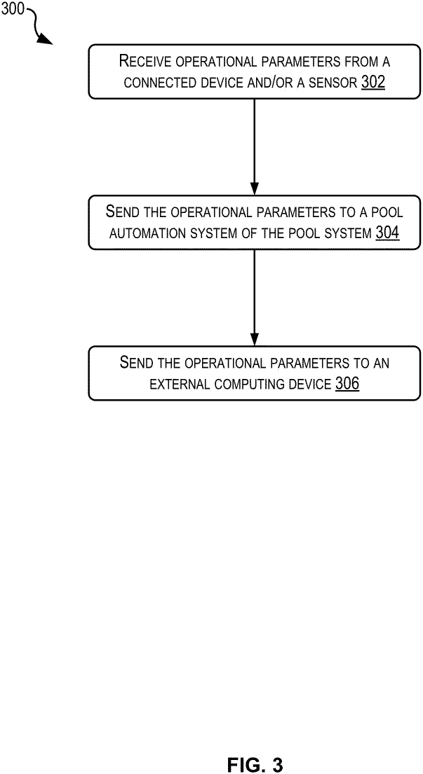

FIGS. 3, 4, 5, and 6 illustrate example flow diagrams showing processes 300, 400, 500, and 600, according to at least a few examples. These processes, and any other processes described herein, are illustrated as logical flow diagrams, each operation of which represents a sequence of operations that can be implemented in hardware, computer instructions, or a combination thereof. In the context of computer instructions, the operations may represent computer-executable instructions stored on one or more non-transitory computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, some, any, or all of the processes described herein may be performed under the control of one or more computer systems configured with specific executable instructions and may be implemented as code (e.g., executable instructions, one or more computer programs, or one or more applications) executing collectively on one or more processors, by hardware, or combinations thereof. As noted above, the code may be stored on a non-transitory computer-readable storage medium, for example, in the form of a computer program including a plurality of instructions executable by one or more processors.

FIG. 3 illustrates a flow chart depicting an example process 300 for controlling and/or monitoring pool equipment based on operational parameter sharing, according to at least one example. The process 300 is performed by a pool system (e.g., pool system 100 of FIG. 1). The process 300 in particular corresponds to sharing operational parameters of pool equipment 102 (e.g., lighting devices, heaters, pumps, etc.).

The process 300 begins at block 302 by a controller (e.g., the controller 107, 207) receiving operational parameters from a connected device (e.g., the user device 106(1), a lighting device, lighting system, etc.) and/or sensors of the pool equipment 102. The controller may be located within the pool equipment 102, although it need not be. The receiving may be performed using a first communication protocol. For example, the first communication protocol may be a PLC protocol.

In some examples, the controller may be configured to collect the operational parameters from multiple different pieces of equipment, user devices, sensors, and other connected devices of a pool system. In this way, a single piece of equipment may function as a hub for the pool system. This may be useful in legacy systems that include legacy components that do not include functionality to communicate directly with a user device and/or a pool automation system using a certain protocol (e.g., Bluetooth, Wi-Fi, etc.).

At block 304, the process 300 includes the controller and, using a second communication protocol, sending the operational parameters to a pool automation system 104 of the pool system 100. This may include sending the operational parameters via a serial interface that includes a hard-wired connection between the pool equipment and the pool automation system 104. This may be possible because the controller maintains addresses of the various connected devices. The controller may poll the various connected devices for the operational parameters and/or the devices may report to the controller (e.g., periodically, responsive to an event, etc.).

At block 306, the process 300 includes the pool automation system 104 and, using a third communication protocol, sending the operational parameters to an external computing device (e.g., the server system 110, the user device 106(2), etc.). For example, these parameters may be sent via the Internet 108, Bluetooth, or other communication protocol. In some examples, at least one of the controller, the pool automation system 104, or the external computing device is further configured to store the operational parameters. In some examples, each of the first, second, and third communication protocols is distinct. In some examples, the first communication protocol is a power line communication (PLC) scheme, the second communication protocol is a serial communication (e.g., RS-485), and the third communication protocol is at least one of Ethernet, Wi-Fi, or Bluetooth. In some examples, the pool automation system 104 adds its own operational parameters as part of sending the operational parameters to the external computing device (e.g., a user device, cloud-connected server, etc.).

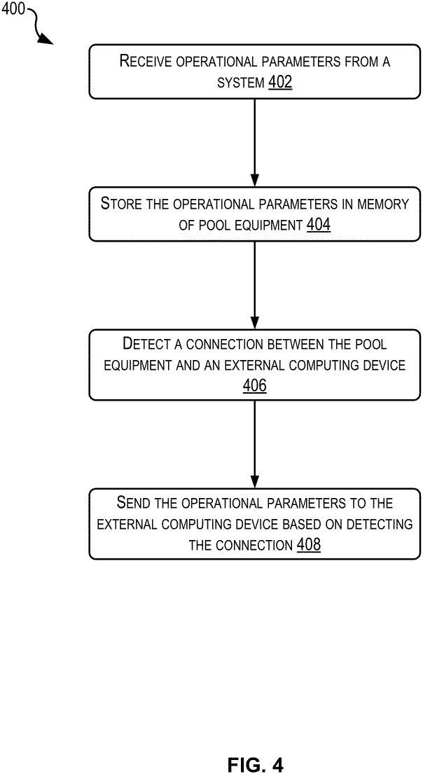

FIG. 4 illustrates a flow chart depicting an example process 400 for controlling and/or monitoring pool equipment based on operational parameter sharing, according to at least one example. The process 400 is performed by one or more components of a pool system (e.g., the pool system 200 of FIG. 2). The process 400 in particular corresponds to sharing operational parameters of the pool automation system with an external computing device.

The process 400 begins at block 402 by pool equipment 202 receiving operational parameters from the pool automation system 204. This may be performed using a first communication protocol (e.g., a serial interface). In some examples, a controller of pool equipment may receive the operational parameters. The equipment may include two or more communication interfaces such that the equipment can function to receive parameters, store parameters, and send parameters. The pool automation system may be part of the pool system.

At block 404, the process 400 includes the pool equipment 202 storing the operational parameters in memory of the pool equipment 202. For example, a controller of the pool equipment may be configured to store operational logs and/or other operational parameters in the memory. This may include storing the parameters in the memory periodically, responsive to events, and in any other fashion. For example, the memory may be used to store weekly parameters, parameters associated with fault events, and the like.

At block 406, the process 400 includes the pool equipment 202 detecting a connection between the pool equipment 202 and an external computing device (e.g., the user device 206). The connection may include a network connection such as a Bluetooth connection. In some examples, proximity awareness of the user device 206 and/or the pool equipment 202 may be used to trigger connection of the pool equipment 202 and the external computing device. The proximity detection may be based on a network connection such as Bluetooth or WiFi, depending on the embodiment. In some examples, the connection between the pool equipment and the external computing device may require at least some level of user authentication. In other examples, the connection may be made without user authentication. In some examples, the connection may occur automatically. For example, after a user device has first connected to the pool equipment, the connection may be automatic the next time the user device gets within network distance of the pool equipment.

At block 408, the process 400 includes the pool equipment 202 sending the operational parameters to the external computing device based on detecting the connection. This may be performed using a second communication protocol. In some examples, each of the first and second communication protocols is distinct. In some examples, the first communication protocol may include a power line communication (PLC) scheme and the second communication protocol may include at least one of Wi-Fi or Bluetooth.

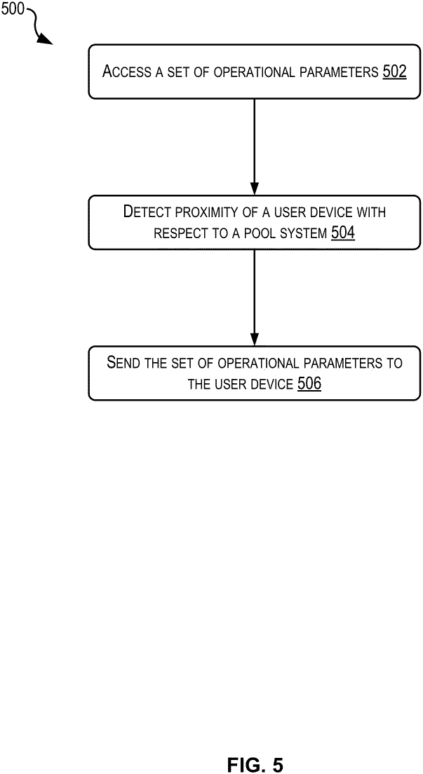

FIG. 5 illustrates a flow chart depicting an example process 500 for controlling and/or monitoring pool equipment based on operational parameter sharing, according to at least one example. The process 500 is performed by a pool system (e.g., pool system 100 of FIG. 1). The process 500 in particular corresponds to sharing operational parameters of pool equipment 102 (e.g., lighting devices, heaters, pumps, etc.) and/or a pool automation system.

The process 500 begins at block 502 by a controller (e.g., the controller 107, 109) accessing a set of operational parameters. Accessing the set of operational parameters may include generating the set of operational parameters based on one or more present or past conditions of the pool system. In some examples, accessing the set of operational parameters may include receiving the operational parameters from a pool automation system of the pool system.

In some examples, the controller may be included in the pool equipment. In some examples, the set of operational parameters may relate to operation of the pool equipment. In some examples, the set of operational parameters may relate to operation of a pool automation system.

At block 504, the process 500 includes the controller detecting proximity of a user device with respect to a pool system. Detecting proximity of the use device may be performed using the techniques described herein, such as, described with respect to block 406.

At block 506, the process 500 includes the controller, responsive to detecting the proximity of the user device, sending the set of operational parameters to the user device. In some examples, the user device may be configured to share the operational parameters with a cloud-connected server system responsive to sending the operational parameters to the user device. In some examples, sending the operational parameters to the user device may include sending the operational parameters via Bluetooth.

In some examples, receiving the set of operational parameters may include receiving via a first communication protocol. In some examples, sending the set of operational parameters may include sending via a second communication protocol. The first communication protocol may include power line communication (PLC) and the second communication protocol may include Bluetooth.

In some examples, the process 500 may further include receiving, from the user device, a change to at least one operational parameter, and responsive to receiving the signal, configuring the operation of a component of the pool system based on the change to at least one operational parameter. In some examples, the process 500 may further include connecting to the user device responsive to detecting the proximity of the user device. In some examples, the process 500 may further include sending the set of operational parameters to a cloud-connected server. In some examples, the process 500 may further include sending other information to the user device. The other information may also relate to the operation of the pool system. Though, this information may relate to authentication of the user device and/or to perform any other function.

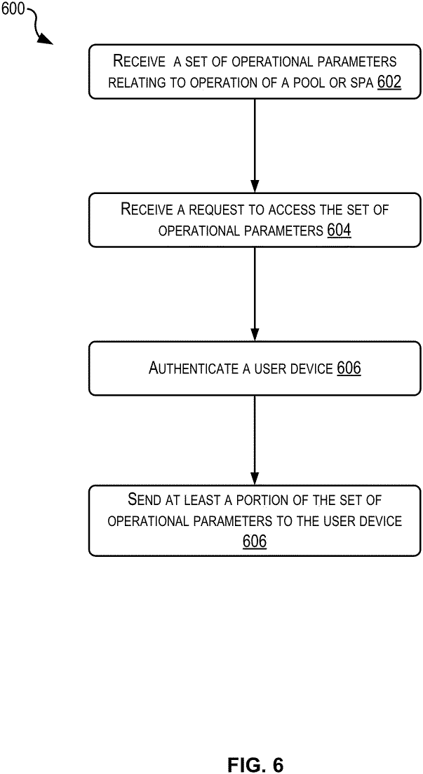

FIG. 6 illustrates a flow chart depicting an example process 600 for controlling and/or monitoring pool equipment based on operational parameter sharing, according to at least one example. The process 600 is performed by a cloud-connected server system (e.g., server system 110 of FIG. 1). The process 600 in particular corresponds to sharing operational parameters of pool equipment 102 (e.g., lighting devices, heaters, pumps, etc.) and/or a pool automation system via the cloud-connected server system.

The process 600 begins at block 602 by a processor of the server system 110 (e.g., the processor 111) receiving a set of operational parameters relating to operation of a pool or spa. As noted above, block 602 may be include receiving at the server system.

At block 604, the process 600 includes the server system 110 receiving a request to access the set of operational parameters. The request may come from a user device, such as one associated with operating, using, and/or maintaining the pool or spa system.

At block 606, the process 600 includes the server system 110, responsive to receiving the request, authenticating the user device. This may include exchanging communications with the user device to authenticate a user profile associated with the user device. For example, the user may be required to sign into an account using a username and password. Other types of authentication such as may be evident for this situation may also be used. The use profile may be a user profile of a user that operates the pool or spa or is authorized to perform repairs on the pool or spa.

At block 608, the process 600 includes the server system 110 sending at least a portion of the set of operational parameters to the user device. Sending at least the portion of the set of operational parameters may include doing so after authenticating the user device.

The process 600 may further include storing the set of operational parameters in a storage location that is associated with an owner or operator of the pool or spa. In some examples, the process 600 may further include storing the set of operational parameters in a storage location that is associated with an authorized technician associated with the pool or spa.

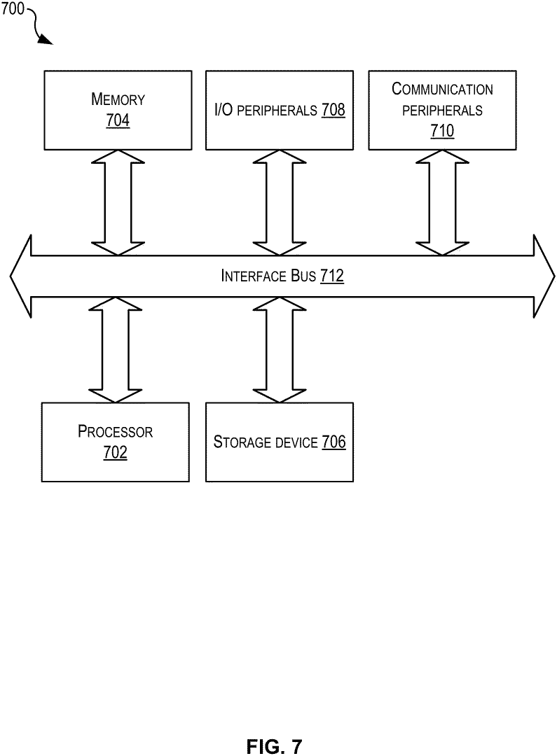

FIG. 7 illustrates examples of components of a computer system 700, according to at least one example. The computer system 700 may be a single computer such as a user computing device and/or can represent a distributed computing system such as one or more server computing devices. The computer system 700 is an example of the external computing devices, controllers and/or microcontrollers of pool equipment and/or pool automation systems, and the like.

The computer system 700 may include at least a processor 702, a memory 704, a storage device 706, input/output peripherals (I/O) 708, communication peripherals 710, and an interface bus 712. The interface bus 712 is configured to communicate, transmit, and transfer data, controls, and commands among the various components of the computer system 700. The memory 704 and the storage device 706 include computer-readable storage media, such as Radom Access Memory (RAM), Read ROM, electrically erasable programmable read-only memory (EEPROM), hard drives, CD-ROMs, optical storage devices, magnetic storage devices, electronic non-volatile computer storage, for example Flash® memory, and other tangible storage media. Any of such computer-readable storage media can be configured to store instructions or program codes embodying aspects of the disclosure. The memory 704 and the storage device 706 also include computer-readable signal media. A computer-readable signal medium includes a propagated data signal with computer-readable program code embodied therein. Such a propagated signal takes any of a variety of forms including, but not limited to, electromagnetic, optical, or any combination thereof. A computer-readable signal medium includes any computer-readable medium that is not a computer-readable storage medium and that can communicate, propagate, or transport a program for use in connection with the computer system 700.

Further, the memory 704 includes an operating system, programs, and applications. The processor 702 is configured to execute the stored instructions and includes, for example, a logical processing unit, a microprocessor, a digital signal processor, and other processors. The memory 704 and/or the processor 702 can be virtualized and can be hosted within another computing system of, for example, a cloud network or a data center. The I/O peripherals 708 include user interfaces, such as a keyboard, screen (e.g., a touch screen), microphone, speaker, other input/output devices, and computing components, such as graphical processing units, serial ports, parallel ports, universal serial buses, and other input/output peripherals. The I/O peripherals 708 are connected to the processor 702 through any of the ports coupled to the interface bus 712. The communication peripherals 710 are configured to facilitate communication between the computer system 700 and other computing devices over a communications network and include, for example, a network interface controller, modem, wireless and wired interface cards, antenna, and other communication peripherals.

In the following, further clauses are described to facilitate the understanding of the present disclosure.

Clause 1. In this clause, there is provided a computer-implemented method for sharing operational parameters for operational control of a pool or spa, comprising:
accessing a set of operational parameters;
detecting proximity of a user device with respect to a pool system; and
responsive to detecting the proximity of the user device, sending the set of operational parameters to the user device.

Clause 2. The computer-implemented method of clause 1, further comprising:
receiving, from the user device, a change to at least one operational parameter; and
responsive to receiving the change, configuring the operation of a component of the pool system based on the change to the at least one operational parameter.

Clause 3. The computer-implemented method of clause 1, further comprising connecting to the user device responsive to detecting the proximity of the user device.

Clause 4. The computer-implemented method of clause 1, wherein accessing the set of operational parameters comprises generating the set of operational parameters based on one or more present or past conditions of the pool system.

Clause 5. The computer-implemented method of clause 1, wherein accessing the set of operational parameters comprises receiving the operational parameters from a pool automation system of the pool system.

Clause 6. The computer-implemented method of clause 1, further comprising sending the set of operational parameters to a cloud-connected server.

Clause 7. The computer-implemented method of clause 1, wherein the user device is configured to share the operational parameters with a cloud-connected server system responsive to sending the operational parameters to the user device.

Clause 8. One or more non-transitory computer-readable media comprising computer-executable instructions that, when executed by one or more processors of a computer system, cause the computer system to perform operations relating to sharing operational parameters for operational control of a pool or spa, wherein the operations comprise:
accessing a set of operational parameters;
detecting proximity of a user device with respect to a pool system; and
responsive to detecting the proximity of the user device, sending the operational parameters to the user device.

Clause 9. The one or more non-transitory computer-readable media of clause 8, wherein the operations further comprise sending other information to the user device.

Clause 10. The one or more non-transitory computer-readable media of clause 8, wherein sending the operational parameters to the user device comprises sending the operational parameters via Bluetooth.

Clause 11. The one or more non-transitory computer-readable media of clause 8, wherein the operations further comprise receiving the set of operational parameters from a pool automation system.

Clause 12. The one or more non-transitory computer-readable media of clause 11, wherein receiving the set of operational parameters comprises receiving via a first communication protocol, and wherein sending the set of operational parameters comprises sending via a second communication protocol.

Clause 13. The one or more non-transitory computer-readable media of clause 12, wherein the first communication protocol comprises power line communication (PLC) and the second communication protocol comprises Bluetooth.

Clause 14. A pool system for sharing operational parameters for operational control of a pool or spa, the pool system comprising:
a controller configured to:
   access a set of operational parameters;
   detect proximity of a user device with respect to a pool system; and
   responsive to detecting the proximity of the user device, send the operational parameters to the user device.

Clause 15. The pool system of clause 14, further comprising pool equipment, wherein the controller is included in the pool equipment.

Clause 16. The pool system of clause 15, wherein the set of operational parameters relate to operation of the pool equipment.

Clause 17. The pool system of clause 15, wherein the set of operational parameters relate to operation of a pool automation system.

Clause 18. The pool system of clause 14, further comprising a pool automation system, wherein the controller is included in the pool automation system, and wherein the set of operational parameters relate to operation of the pool automation system or a device controlled by the pool automation system.

Clause 19. A computer-implemented method for sharing operational parameters for operational control of a pool or spa, the computer-implemented method comprising:
receiving, at a cloud-connected server system, a set of operational parameters relating to operation of the pool or spa;
receiving, from a user device, a request to access the set of operational parameters;
responsive to receiving the request, authenticating the user device; and
after authenticating the user device, sending at least a portion of the set of operational parameters to the user device.

Clause 20. The computer-implemented method of clause 19, wherein the user device is associated with a user profile of a user that operates the pool or spa or is authorized to perform repairs on the pool or spa.

Clause 21. The computer-implemented method of clause 19, wherein authenticating the user device comprises authenticating the user device based on a user profile associated with the user device.

Clause 22. The computer-implemented method of clause 19, further comprising storing the set of operational parameters in a storage location that is associated with an owner or operator of the pool or spa.

Clause 23. The computer-implemented method of clause 19, further comprising storing the set of operational parameters in a storage location that is associated with an authorized technician associated with the pool or spa.

Clause 24. The computer-implemented method of clause 19, wherein receiving the set of operational parameters comprises receiving the set of operational parameters from the user device.

Clause 25. The computer-implemented method of clause 19, wherein the user device is a first user device, and wherein receiving the set of operational parameters comprises receiving the set of operational parameters from a second user device that is distinct from the first user device.

Clause 26. The computer-implemented method of clause 29, wherein the first user device is associated with a first user profile and the second user device is associated with a second user profile.

Clause 27. The computer-implemented method of clause 19, wherein receiving the set of operational parameters comprises receiving the set of operational parameters a pool automation system.

Clause 28. A method for sharing operational parameters for operational control of a pool or spa, the method comprising:
receiving, by a controller of a pool system and using a first communication protocol, a set of operational parameters from a connected device of the pool system;
sending, by the controller and using a second communication protocol, the operational parameters to a pool automation system of the pool system; and
sending, by the pool automation system and using a third communication protocol, the operational parameters to an external computing device.

Clause 29. The method of clause 28, wherein the controller of the pool system is included in pool equipment and the connected device comprises the pool equipment.

Clause 30. The method of clause 28, further comprising:
storing, by the controller, first copies of the set of operational parameters; and
storing, by the pool automation system, second copies of the set of operational parameters.

Clause 31. The method of clause 28, wherein each of the first, second, and third communication protocol is distinct.

Clause 32. The method of clause 28, wherein the first communication protocol comprises include a power line communication (PLC) protocol.

Clause 33. The method of clause 28, wherein the second communication protocol comprise a serial communication protocol.

Clause 34. The method of clause 28, wherein the third communication protocol comprises at least one of Bluetooth, Ethernet, or Wi-Fi.

Clause 35. A method for sharing operational parameters for operational control of a pool or spa, the method comprising:
receiving, by a controller of pool equipment and using a first communication protocol, operational parameters from an automation system of a pool system;
storing the operational parameters in memory of the pool equipment that is associated with the automation system;
detecting a connection between the pool equipment and an external computing device; and
sending, using a second communication protocol, the operational parameters to the external computing device based on detecting the connection.

Clause 36. The method of clause 35, wherein each of the first and second communication protocols is distinct.

Clause 37. The method of clause 35, wherein the first communication protocol comprises a power line communication (PLC) protocol.

Clause 38. The method of clause 35, wherein the second communication protocol comprises at least one of Wi-Fi or Bluetooth.

Other variations are within the spirit of the present disclosure. Thus, while the disclosed techniques are susceptible to various modifications and alternative constructions, certain illustrated examples thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “having,” “including,” and “containing” are to be construed as open-ended terms (e.g., meaning “including, but not limited to,”) unless otherwise noted. The term “connected” is to be construed as partly or wholly contained within, attached to, or joined together, even if there is something intervening. Recitation of ranges of values herein is merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate examples of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and all three of A and B and C.

Preferred examples of this disclosure are described herein, including the best mode known to the inventors for carrying out the disclosure. Variations of those preferred examples may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

These examples are not intended to be mutually exclusive, exhaustive, or restrictive in any way, and the disclosure is not limited to these example embodiments but rather encompasses all possible modifications and variations within the scope of any claims ultimately drafted and issued in connection with the invention (and their equivalents). For avoidance of doubt, any combination of features not physically impossible or expressly identified as non-combinable herein may be within the scope of the disclosure. Further, although applicant has described devices and techniques for use principally with pool systems, persons skilled in the relevant field will recognize that the present invention conceivably could be employed in connection with other objects and in other manners. Finally, references to “pools” and “swimming pools” herein may also refer to spas or other water containing vessels used for recreation or therapy.

What is claimed is:

1. A computer-implemented method for sharing operational parameters for operational control of a pool or spa, comprising:
accessing a set of operational parameters;
detecting proximity of a user device with respect to a pool system; and
responsive to detecting the proximity of the user device, sending the set of operational parameters to the user device.

2. The computer-implemented method of claim 1, further comprising:
receiving, from the user device, a change to at least one operational parameter; and
responsive to receiving the change, configuring the operation of a component of the pool system based on the change to the at least one operational parameter.

3. The computer-implemented method of claim 1, further comprising connecting to the user device responsive to detecting the proximity of the user device.

4. The computer-implemented method of claim 1, wherein accessing the set of operational parameters comprises generating the set of operational parameters based on one or more present or past conditions of the pool system.

5. The computer-implemented method of claim 1, wherein accessing the set of operational parameters comprises receiving the operational parameters from a pool automation system of the pool system.

6. The computer-implemented method of claim 1, further comprising sending the set of operational parameters to a cloud-connected server.

7. The computer-implemented method of claim 1, wherein the user device is configured to share the operational parameters with a cloud-connected server system responsive to sending the operational parameters to the user device.

8. One or more non-transitory computer-readable media comprising computer-executable instructions that, when executed by one or more processors of a computer system, cause the computer system to perform operations relating to sharing operational parameters for operational control of a pool or spa, wherein the operations comprise:
accessing a set of operational parameters;
detecting proximity of a user device with respect to a pool system; and
responsive to detecting the proximity of the user device, sending the operational parameters to the user device.

9. The one or more non-transitory computer-readable media of claim 8, wherein the operations further comprise sending other information to the user device.

10. The one or more non-transitory computer-readable media of claim 8, wherein sending the operational parameters to the user device comprises sending the operational parameters via Bluetooth.

11. The one or more non-transitory computer-readable media of claim 8, wherein the operations further comprise receiving the set of operational parameters from a pool automation system.

12. The one or more non-transitory computer-readable media of claim 11, wherein receiving the set of operational parameters comprises receiving via a first communication protocol, and wherein sending the set of operational parameters comprises sending via a second communication protocol.

13. The one or more non-transitory computer-readable media of claim 12, wherein the first communication protocol comprises power line communication (PLC) and the second communication protocol comprises Bluetooth.

14. A pool system for sharing operational parameters for operational control of a pool or spa, the pool system comprising:
a controller configured to:
access a set of operational parameters;
detect proximity of a user device with respect to a pool system; and
responsive to detecting the proximity of the user device, send the operational parameters to the user device.

15. The pool system of claim 14, further comprising pool equipment, wherein the controller is included in the pool equipment.

16. The pool system of claim 15, wherein the set of operational parameters relate to operation of the pool equipment.

17. The pool system of claim 15, wherein the set of operational parameters relate to operation of a pool automation system.

18. The pool system of claim 14, further comprising a pool automation system, wherein the controller is included in the pool automation system, and wherein the set of operational parameters relate to operation of the pool automation system or a device controlled by the pool automation system.

19. A computer-implemented method for sharing operational parameters for operational control of a pool or spa, the computer-implemented method comprising:
receiving, at a cloud-connected server system, a set of operational parameters relating to operation of the pool or spa;
receiving, from a user device, a request to access the set of operational parameters;
responsive to receiving the request, authenticating the user device; and
after authenticating the user device, sending at least a portion of the set of operational parameters to the user device.

20. The computer-implemented method of claim 19, wherein the user device is associated with a user profile of a user that operates the pool or spa or is authorized to perform repairs on the pool or spa.

21. The computer-implemented method of claim 19, wherein authenticating the user device comprises authenticating the user device based on a user profile associated with the user device.

22. The computer-implemented method of claim 19, further comprising storing the set of operational parameters in a storage location that is associated with an owner or operator of the pool or spa.

23. The computer-implemented method of claim 19, further comprising storing the set of operational parameters in a storage location that is associated with an authorized technician associated with the pool or spa.

24. The computer-implemented method of claim 19, wherein receiving the set of operational parameters comprises receiving the set of operational parameters from the user device.

25. The computer-implemented method of claim 19, wherein the user device is a first user device, and wherein receiving the set of operational parameters comprises receiving the set of operational parameters from a second user device that is distinct from the first user device.

26. The computer-implemented method of claim 29, wherein the first user device is associated with a first user profile and the second user device is associated with a second user profile.

27. The computer-implemented method of claim 19, wherein receiving the set of operational parameters comprises receiving the set of operational parameters a pool automation system.

28. A method for sharing operational parameters for operational control of a pool or spa, the method comprising:
receiving, by a controller of a pool system and using a first communication protocol, a set of operational parameters from a connected device of the pool system;
sending, by the controller and using a second communication protocol, the operational parameters to a pool automation system of the pool system; and
sending, by the pool automation system and using a third communication protocol, the operational parameters to an external computing device.

29. The method of claim 28, wherein the controller of the pool system is included in pool equipment and the connected device comprises the pool equipment.

30. The method of claim 28, further comprising:
storing, by the controller, first copies of the set of operational parameters; and
storing, by the pool automation system, second copies of the set of operational parameters.

31. The method of claim 28, wherein each of the first, second, and third communication protocol is distinct.

32. The method of claim 28, wherein the first communication protocol comprises include a power line communication (PLC) protocol.

33. The method of claim 28, wherein the second communication protocol comprise a serial communication protocol.

34. The method of claim 28, wherein the third communication protocol comprises at least one of Bluetooth, Ethernet, or Wi-Fi.

35. A method for sharing operational parameters for operational control of a pool or spa, the method comprising:
receiving, by a controller of pool equipment and using a first communication protocol, operational parameters from an automation system of a pool system;
storing the operational parameters in memory of the pool equipment that is associated with the automation system;
detecting a connection between the pool equipment and an external computing device; and
sending, using a second communication protocol, the operational parameters to the external computing device based on detecting the connection.

36. The method of claim 35, wherein each of the first and second communication protocols is distinct.

37. The method of claim 35, wherein the first communication protocol comprises a power line communication (PLC) protocol.

38. The method of claim 35, wherein the second communication protocol comprises at least one of Wi-Fi or Bluetooth.
